(19) United States
(12) Patent Application Publication
(10) Pub. No.: US 2015/0208801 A1
(43) Pub. Date: Jul. 30, 2015

(54) Slidable storage container and sliding mechanism

(71) Applicant: Yajun Hu, El Dorado Hills, CA (US)

(72) Inventor: Yajun Hu, El Dorado Hills, CA (US)

(21) Appl. No.: 14/164,210

(22) Filed: Jan. 26, 2014

(51) Int. Cl. A47B 88/00; F16M 13/02; A47B 88/16; A47B 88/04

(52) U.S. Cl. CPC A47B 88/0085; A47B 88/04; F16M 13/022; A47B 88/16; A47B 2088/0448

(57) ABSTRACT

Slidable storage container assembly is constructed through the main component of storage container and locating connection of the sliding trail. This assembly can reduce the maintenance costs and increase efficiency. The assembly is particularly applicable to mesh storage container. Moreover, the slidable storage container assembly and sliding trail has simple configuration, easy to mount and dismount. The storage container assembly includes the storage container and sliding device with fastening connection and locating connection. The assembly can be easily dismounted when the storage container and sliding device is malfunction or needs to be replaced. The procedures of position adjustment and dismounting of the main component can be avoided, that conveniently speeds up the installation and dismounting, therefore it is beneficial to the office and other uses.

### BACKGROUND

1. Field of the Disclosure

This invention is generally directed to store and organize products, and more particularly to a storage container that can be used to store and organize the daily necessities and office supplies.

2. Description of Related Art

The cabinet or box or basket is usually used as a storage container in the most modern storage device. Frequent movement of storage container is often required for easy access. It is convenient and fast to use pulley for some entirely independent storage containers, however, other dependent containers such as drawers in the cabinet, that have to be attached to another unit, a more complicated device such as sliding trail needs to be used instead of the pulley.

There are two existing trail mechanisms, one is stationary trail and another is moving trail. The dependent storage container mentioned above is fixed by screws and attached on the moving trail that couples with stationary trail for sliding movement. Whenever there are malfunctioning of device or it needs to be replaced, the mounting and dismounting procedures of main body of this kind of storage container is very tedious, which dramatically increases maintenance costs. Furthermore, mounting, adjusting and fixing the main component of the storage container are very time consuming which affect the progress of the installation, and reduces efficiency.

There are three drawbacks for the storage container described above: 1 it might cause some damages for the main component of dependent storage container during installation; 2. The main component of the storage container and the trail device cannot be assembled effectively for fixing installation for mesh storage container, especially when the parts of stationary trail is in mesh structures. 3. The mounting and dismounting procedures of main component of storage container and trail device are extremely complicated.

Therefore, it is critical to design a slidable storage container with simple sliding configuration that can be easily mounted and dismounted to reduce the maintenance costs, improve efficiency without damaging the main component of the storage container for widely uses in various circumstances.

### SUMMARY OF THE DISCLOSURE

The storage container assembly disclosed herein overcomes the disadvantages and drawbacks, provides a simple way to install a slidable storage container that can reduce the maintenance costs, improve efficiency without interfering the parts of assembly, the assembly is particularly applicable to slidable mesh storage container. Moreover, a slidable storage container assembly and a sliding device with simple construction is easy to mount and dismount. It is suitable for widely uses in various circumstances.

The storage container can be slid by riveting to the sliding device. The sliding of main component of storage container and the sliding device is implemented through sliding mechanism by fastening connection or locating connection.

The assembly is easy to operate. Dismounting the relevant parts is required only when there is malfunction for the main body of storage container and sliding device or they need to be replaced. There is no need for location adjusting and fixing part dismounting, which greatly improves the speed and provides convenience for installation and dismounting of storage container, and reduces the maintenance cost and increases the efficiency. Importantly, it implements the sliding mechanism without interfering of the main component of storage container.

### BRIEF DESCRIPTION OF THE DRAWINGS

Objects, features, and advantages of this invention will be clear upon reading the following descriptions in conjunction with the drawing figures, in which:

FIG. 1 show a perspective view of the storage container—basket;

FIG. 2 show a perspective view of the sliding trail with pull back position;

FIG. 3 show a perspective view of sliding trail with pull out position;

FIG. 4 show whole set of storage container;

FIG. 5 show the whole set of storage container in side view;

FIG. 6 show whole set of storage container placed on the wire shelf with pull pack position;

FIG. 7 show the whole set of storage container placed on the wire shelf with pull out position;

FIG. 8 show perspective view of the whole set of storage container placed on the wood shelf with pull back position;

FIG. 9 show perspective view of whole set of storage container placed on the wood shelf with pull out position;

Figure Notes: 1. Storage container; 2. Locating lever; 3. Moving trail; 4 Locating part two; 5. Stationary trail; 6. Handle; 7. Rim; 8, Wire shelf; 9, Wood shelf; 10. Screw; 11. Bracket; 12. Fixed lever.

### DETAILED DESCRIPTION OF THE DISCLOSURE

The fastening connection refers to fastening part one in the main body of storage container and the fastening part two in the sliding device that are coupled; and the locating connection refers to locating part one in the main body of storage container and the locating part two in the sliding device that are coupled to achieve the sliding movement of the storage container assembly. The fastening connection of fastening part one and fastening part two, or locating connection of locating part one and locating part two makes the firm connection and enhances the stability of storage container and sliding device.

More specifically, fastening part one or locating part one are fixed at the bottom of the storage container. The fastening part two and locating part two are fixed on the moving parts of the sliding device. It is the fastening connection between fastening part one and fastening part two, incorporates with the locating connection between the locating part one and locating part two, that achieves the relative sliding between storage container and stationary part of sliding device.

The storage container described is in mesh structure. The sliding mechanism is particularly suitable for mesh storage container.

The slidable storage container assembly includes the main body of storage container and sliding device, and the fastening connection and locating connection of between the main body of storage container and sliding device.

The assembly is easy to construct, easy to mount and dismount. Therefore it can be widely used in various circumstances.

The main component of storage container consists of the fastening part one and locating part one; the sliding device consists of fastening part two and locating part two. The sliding of storage container can be implemented by fastening part one couples with the fastening part two or locating part one couples with locating part two.

More specifically, the fastening part one is the fastening lever that is placed at the bottom of the storage container, the fastening part two is the fastening part two that is placed on the moving component of sliding device. The locating part one is the locating lever that is placed at the bottom of the storage container. The locating part two is the locating lever that is placed on the moving component of sliding device. The fastening lever or locating lever is welded at the bottom of the storage container.

The sliding device described is a trail configuration. The two locating parts (locating part two) are placed outsides of the trail symmetrically. The locating lever stands between the two locating parts. The fastening part two described is a groove with blockers, the fastening parts are located outside of the moving trail of sliding device, and the fastening lever is locked inside of the groove.

The locating part two is shaped as the Arabic number “3” from the cross section, the two locating parts are placed outsides of the moving trail of sliding device symmetrically, the fastening lever is locked in the “dent” of number 3. The fastening part two is a U-shaped groove with blockers. The two locating parts are shaped as Arabic number “3” from the cross section and are located outside of the moving trail symmetrically. The two locating levers are placed between the two locating parts at the bottom of the storage container. The two fastening levers arc locked on slots of the multiple U-shaped grooves at the bottom of the storage container for stable connection.

The sliding device of the assembly also contains the fixed lever at the bottom of the storage container. The fixed lever and fastening lever or the locating lever are riveted together as a frame, includes the bracket installed at the bottom of sliding device. The bracket is in mesh or plate structure, the storage container is made of metal mesh riveted to the fastening lever or locating lever as a frame which are welded at the bottom of the storage container. Because storage container is made of metal mesh, there are more welding points for the fixed lever and fastening lever that can enhance the stable connection between the storage container and sliding device. The shelf can be made of wood, or wire etc. The brackets of the trail are screwed on the wood shelf or wire shelf, for the sliding movement of the main body of storage container.

Compared with the existing technology, the assembly has the following advantages and benefits:

1. The sliding mechanism is simple and can greatly reduce the maintenance cost, thereby increase the efficiency.

2. The sliding mechanism keeps the whole storage container assembly intact, which is particularly suitable for the mesh storage container.

3. The construction of assembly is quite simple. It is very easy to mount or dismount for the storage container assembly and the sliding device. It requires only dismount relevant parts whenever the storage container or sliding device is malfunction or when it needs to be replaced. There is no need for any position adjustment or dismount for the fixed parts. Thus, it provides the convenience and quickness for installation which is beneficial for widely uses in various circumstances.

### Description of Exemplary Embodiments

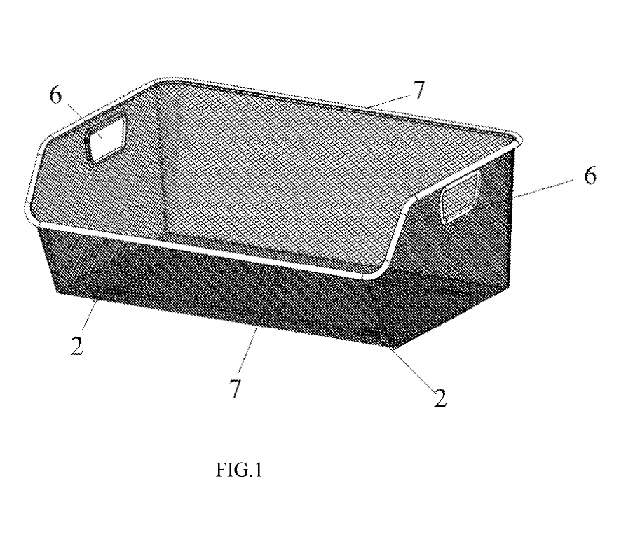

Embodiment 1, the sliding of assembly is implemented by locating connection of a storage container and the moving trail of sliding device. As showed in FIGS. 1-5, a storage container 1 is in mesh structure. In the locating connection, set a locating lever 2 as a locating part one in a storage container 1, and then set locating part two 4 in sliding trail device, the interaction between locating lever 2 and locating part two 4 makes the sliding movement of a storage container. Locating lever 2 is set at the bottom of the storage container 1, and locating part 4 is set on the moving trail 3 of sliding device.

To achieve the relative sliding between storage container 1 and the stationary trail 5, the locking of locating lever 2 at the bottom of the storage container 1 and the locating part two 4 in the sliding device makes the locating connection of the storage container 1 and the moving trail 3 in sliding device. It is particularly suitable for the storage container of a mesh structure to achieve sliding movement due to the systematic coordination among the parts of the storage container.

The sliding storage container assembly includes the main body of storage container and the moving trail in sliding device, and their locating connection. The construction of storage container assembly is very simple and easy to mount and dismount. As showed in the FIGS. 1 & 4, the storage container is made of metal mesh; the handle 6 in both sides makes it more convenient for installation and replacement. The locating lever 2 and fixing lever 12 are placed at the bottom of the container; the two parts are riveted together as a frame and welded at the bottom of the container 1. Because the container 1 is made of the metal mesh, the configuration of locating lever 2 and fix lever 12 can increase welding spots between location lever 2 and the bottom of the storage container 1, which enhances stable connection between the container and trail. In order to enhance the stability and improve appearance of the container, there is a rim 7 made of metal in the upper edge of the body. The inserting slot in the rim matches the path of the mesh.

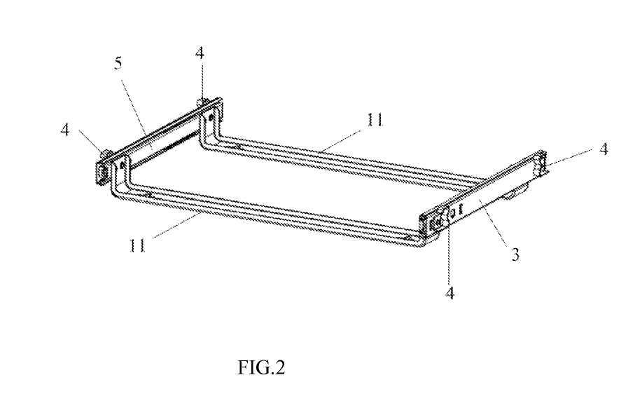

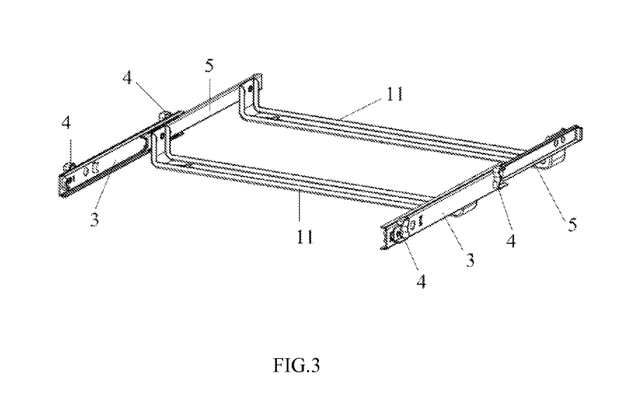

As showed in FIG. 2-3, the sliding mechanism described in the invention includes the stationary trail 5, the bracket 11, and the moving trail 3 which is connected to the stationary trail 5. The locating part two 4 is in the outside of the moving trail 3. The locating part two 4 is shaped as Arabic number “3” from the cross section which is located outside of the moving trail 3 symmetrically.

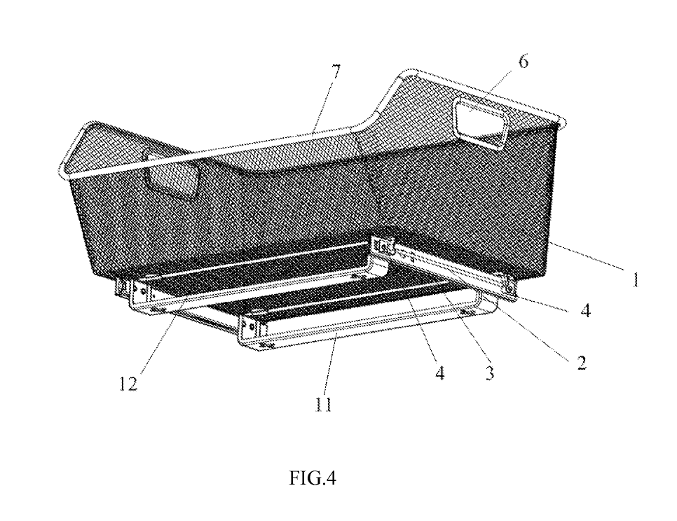

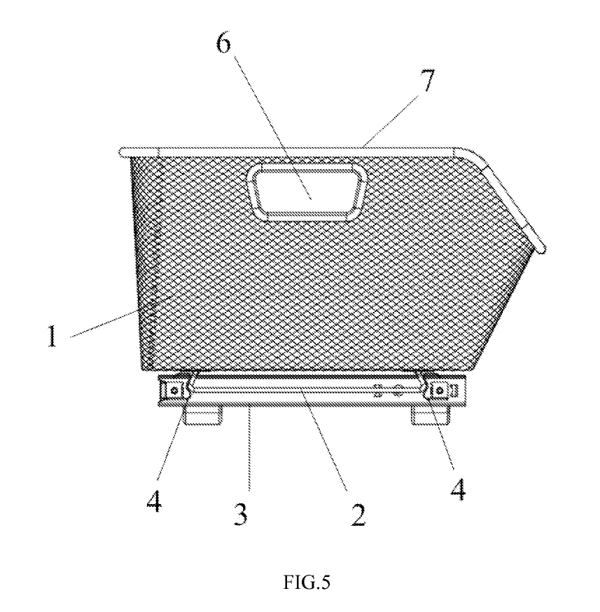

As showed in FIG. 4-5, the locating lever 2 is at the bottom of the container 1 stands between the locating part two 4 and the moving trail 3 symmetrically, to achieve the locating connection between the container and sliding device. The two locating part two 4 is shaped as Arabic number “3” from the cross section located in outside of the moving trail 3 symmetrically, for the locating connection between two locating levers 2 at the bottom of the container 1 and are firmly installed into the dent section in the locating parts.

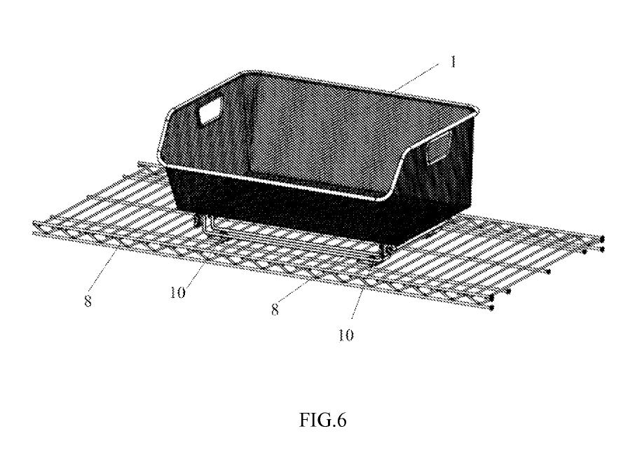

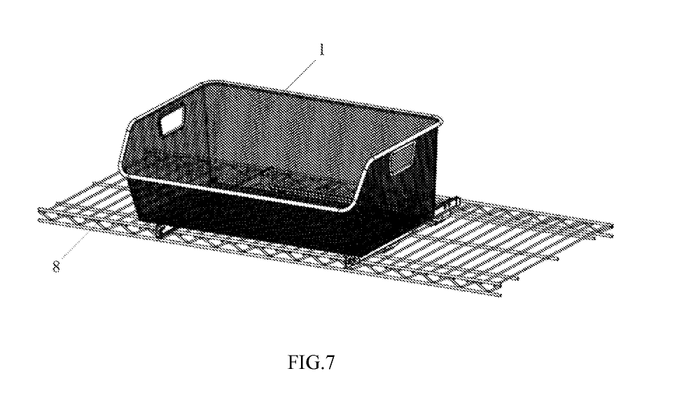

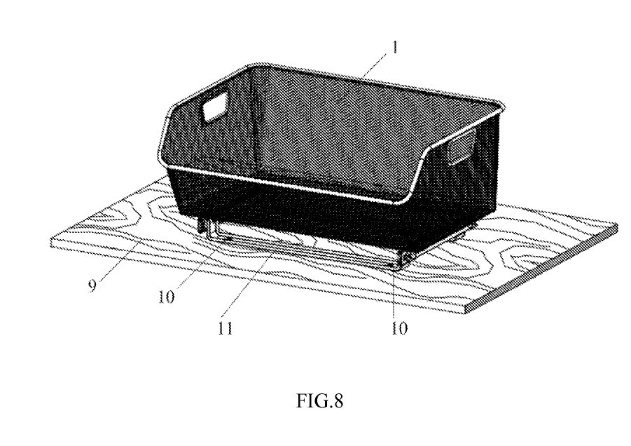

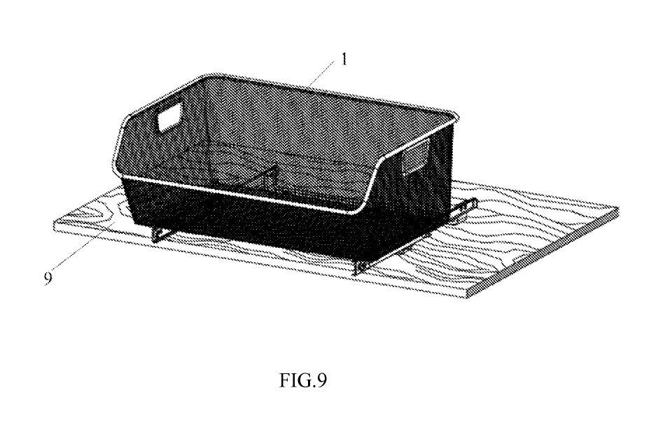

As showed in FIG. 6-9, the assembly also includes the shelf used as stationary trail 5. The shelf is installed at the bottom of the trail. The shelf is made of wood 9, or wire 8 etc. The bracket 11 of the trail is screwed on the wood shelf 9 or wire shelf 8, to achieve the sliding movement of the storage container assembly which is placed on the wood shelf 9 or wire shelf 8.

Embodiments 2, there is no fixed lever 12 at the bottom of the container 1. The locating connection between locating lever 2 welded at the bottom of the container 1 and the locating part two 4 on the moving trail 3 provides the relative sliding movement between the container 1 and the stationary trail 5 on the sliding device. The other constructions are the same as embodiment 1.

Embodiment 3, the storage container assembly is fastening connected with the sliding device to achieve sliding movement between the storage container and sliding device. The container is in mesh structure. In the fastening connection, set the fastening lever in the storage container as fastening part one, and set the fastening part two in sliding device. The sliding movement can be achieved by interaction of fastening part one and fastening part two. The fastening lever is at the bottom of the container, the fastening part two is in the trail.

The assembly achieves the relative sliding movement between the storage container and trail by the interaction between the fastening lever and the fastening part connected at the bottom of container 1. It is particularly suitable for the container with mesh structure to achieve sliding movement based on the integrity of the storage container.

The sliding storage container assembly includes the storage container and the sliding device, the fastening connection of sliding device and the main component of storage container. The construction of the container assembly is simple, easy to mount and dismount. It is made of metal mesh, and the handles 6 on both sides make it more convenient for mounting or dismounting. There are fastening lever and fixed lever 12 at the bottom of the container 1; the two parts are connected together as a frame welded at the bottom of the container 1. Because container 1 is made of metal mesh, there are more welding points for the fixed lever 12 and fastening lever, which enhance the connection between the main component of storage container and sliding device. In order to improve the stability and appearance of the container, there is the rim 7 made of metal in the upper edge of the storage container. The inserting slot in the rim matches the path of the mesh.

The sliding device mentioned in the invention includes the stationary trail 5, the bracket 11 and the moving trail 3 that are connected to the stationary trail 5. There are more than two fastening parts that are placed outside of the moving trail 3, and the “U” shaped dent of fastening part two. The two fastening levers at the bottom of the container are locked into the multiple “U” shaped dents of fastening part two outside of the moving trail 3 separately for the firmly fastening connection between the storage container and the sliding device.

The invention also includes the shelf used as a stationary trail 5. The shelf is installed at the bottom of the trail. The shelf can be made of wood 9, or wire 8 etc. The bracket 11 of the trail is screwed on the wood shelf 9 or wire 8, for the sliding movement of the container assembly placed on the wood shelf 9 or wire shelf 8.

Embodiments 4, there is no fixed lever 12 at the bottom of the container 1. The connection between the fastening lever welded at the bottom of the container 1 and the fastening part two in the moving trail 3 makes relative sliding movement between the container 1 and stationary trail 5. The other constructions are the same as embodiment 3.

The embodiments described above are the preferred embodiment of the invention, but the invention is not limited to above embodiments. Any other changes in the spirit of principles in the invention including modification, replacement, combinations, simplification of the replacement pattern should be equivalent, are included within the scope of the present invention.

The embodiments of the invention in which an exclusive property or privilege is claimed are defined as follows:

1. The sliding mechanism of slidable storage container assembly, including the fastening connection or locating connection between the storage container and the sliding device.

2. The sliding mechanism of the storage container assembly according to claim 1, wherein the fastening part one in the storage container, fastening part two in the sliding device for the sliding movement by interaction of fastening part one and fastening part two; the locating part one in the container, locating part two in the sliding devices for the sliding movement of the storage container by interaction of locating part one and locating part two.

3. The sliding mechanism of the storage container according to claim 2, wherein the fastening part one or locating part one is fixed at the bottom of the container; the fastening part two and locating part two is fixed on the moving trail.

4. The sliding mechanism of the storage container according to claims 1-3, wherein the container is in mesh structure.

5. The slidable storage container assembly, including the storage container and sliding device, and the fastening and locating connection between the main component and the sliding device.

6. The slidable storage container assembly according to claim 5, including the fastening part one or locating part one in the storage container, the fastening part two or locating part two in the sliding device; the coupling between fastening part one and fastening part two, and locating part one and locating part two.

7. The slidable storage container assembly according to claim 6, including the fastening lever is placed at the bottom of the storage container, the fastening part two is placed on the moving trail of sliding device; the locating lever is placed at the bottom of the storage container, the locating part two is placed on the moving trail of sliding device.

8. The slidable storage container assembly according to claim 7, wherein the sliding trail is a moving trail device; the two locating parts are symmetrically located outside of moving trail; the locating lever stands between the two locating part two; the fastening part is the groove with blockers, the fastening parts are located at outside of the moving trail; the fastening lever is locked inside of the groove.

9. The slidable storage container assembly according to claim 8, wherein the locating part two is shaped as Arabic number “3” from the cross section, the two locating parts are symmetrically located outside of the moving trail, the fastening lever is blocked in the dent of number “3”; the fastening part two is the U shaped groove with blocks.

10. The slidable storage container assembly according to claims of 7-9, including the fixed lever at the bottom of the container, the fixed lever and fastening lever or locating lever that are riveted together as a frame, the bracket at the bottom of sliding device; the frame in mesh structure or in plate structure; the storage container that is made of metal mesh.
